(19) United States
(12) Patent Application Publication
(10) Pub. No.: US 2010/0088461 A1
(43) Pub. Date: Apr. 8, 2010

(54) SOLID STATE STORAGE SYSTEM USING GLOBAL WEAR LEVELING AND METHOD OF CONTROLLING THE SOLID STATE STORAGE SYSTEM

(76) Inventors: Wun Mo YANG, Gyeonggi-do (KR); Kyeong Rho KIM, Gyeonggi-do (KR); Jeong Soon KWAK, Gyeonggi-do (KR)

Correspondence Address: LADAS & PARRY LLP, 224 SOUTH MICHIGAN AVENUE, SUITE 1600, CHICAGO, IL, 60604, US

(21) Appl. No.: 12/344,702

(22) Filed: Dec. 29, 2008

(30) Foreign Application Priority Data
Oct. 2, 2008 (KR) 10-2008-0097184

(51) Int. Cl. G06F 12/00; G06F 12/02; G06F 12/06

(52) U.S. Cl. 711/103; 711/166; 711/170; 711/E12.001; 711/E12.103; 711/E12.078

(57) ABSTRACT

A solid state storage system is disclosed including a memory area having a plurality of chips. The solid state storage system includes a micro controller unit (MCU) configured to utilize the number of deletions for logical blocks corresponding to logical block addresses when performing wear leveling on the memory area. The allocation of the logical block addresses can be performed using an interleaving process and a multi-plane method. The solid state storage system performs global wear leveling by which the lifespan of the cells of the chips can be uniformly managed.

### CROSS-REFERENCES TO RELATED PATENT APPLICATION

The present application claims priority under 35 U.S.C 119(a) to Korean Application No. 10-2008-0097184, filed on Oct. 2, 2008, in the Korean Intellectual Property Office, which is incorporated herein by reference in its entirety as set forth in full.

### BACKGROUND

1. Technical Field

The present invention described herein relates generally to a solid state storage system and a method of controlling the solid state storage system, and more particularly, to a solid state storage system that can control allocation of memory blocks and a method of controlling the solid state storage system.

2. Related Art

In recent years, solid state storage systems, such as solid state drives (SSD) that use NAND flash memories, have introduced various algorithms and control methods to improve system performance.

In a solid state storage system, data is repeatedly written and updated to NAND flash memory cells.

In general, when data of a NAND flash memory cell is updated, the data that is previously stored in the NAND flash memory cell is deleted and new data is written in the NAND flash memory cell. This process occurs because the NAND flash memory is a form of non-volatile memory. However, when data is written to the NAND flash memory, data is not uniformly programmed across all memory cells, but rather the data may be primarily programmed in a specific cell area. That is, the memory cells may become worn out due to frequent write and delete processes in the specific cell area or in cells corresponding to data. However, the overall performance of the solid state storage system may be restricted due to the worn cells even though there may be cells that exist in a fresh state.

To address the deterioration of the memory cells, wear leveling is performed to change physical locations of each memory zone or a storage cell in a plane to control uniform utilization of the cells before each memory cell is worn out.

However, since the wear leveling is performed in a corresponding plane or a corresponding chip, even if the use frequency of each cell is equalized, the overall performance of the system may be restricted due to the frequent utilization of a specific plane or a specific chip where data is frequently written.

Accordingly, it is necessary to introduce a method for preventing data storage areas from being concentrated in the same area so as to uniformly manage the lifespan of the cells when wear leveling is performed on the data storage areas. It is also important to consider the concept of global wear leveling (GW) that is performed on all chips and planes.

### SUMMARY

A solid state storage system that can uniformly manage the lifespan of cells is disclosed herein.

A method of controlling a solid state storage system that can uniformly manage the lifespan of cells is also disclosed herein.

In one embodiment of the present invention, a solid state storage system includes a memory area including a plurality of chips; and a micro controller unit (MCU) configured to use the number of times of deleting logical blocks corresponding to logical block addresses, when wear leveling is performed on the memory area.

In another embodiment of the present invention, a solid state storage system includes a memory area including a plurality of chips; and a micro controller unit (MCU) configured to allocate continuous logical block addresses to the different chips, respectively, and perform wear leveling on the memory area. When a logical block having a threshold value of the number of times of deletion is generated, the MCU allocates the logical block to physical blocks of the chips other than the chip including the logical block so as to support global wear leveling.

In another embodiment of the present invention, a method of controlling a solid state storage system using a file system method that manages data in a cluster unit includes increasing the number of times of deleting a logical block designated by a selected logical block address, when data is updated in response to a command from an external host; determining whether the number of times of deleting the logical block address exceeds a threshold value of the number of times of deletion; and mapping the logical block to free blocks of the different chips, when the number of times of deleting the logical block address exceeds the threshold value.

According to one embodiment, addresses are allocated such that data storage areas are uniformly distributed with respect to all memories Since, wear leveling is not limited to a corresponding chip and can be performed on the other chips, it is possible to uniformly manage the lifespan of cells. As a result, the lifespan of the cells can increase, and the lifespan of the SSD can be efficiently managed.

These and other features are described below in the section labeled “Detailed Description.”

### BRIEF DESCRIPTION OF THE DRAWINGS

Features, aspects, and embodiments of the present invention are described in conjunction with the attached drawings, in which:

FIG. 1 is a block diagram showing an exemplary solid state storage system according to one embodiment;

FIG. 2 is a block diagram showing a hierarchical structure of an exemplary memory area that can be included with the system according to one embodiment of the present invention;

FIG. 3 is a conceptual block diagram showing a logical block address mapping relationship according to one embodiment of the present invention; and

FIG. 4 is a conceptual block diagram showing a mapping relationship between logical block addresses and physical block addresses according to one embodiment of the present invention;

FIG. 5 is a block diagram showing a delete management table of logical blocks and a delete management table of physical blocks according to one embodiment of the present invention:

FIG. 6 is a conceptual block diagram showing a process of mapping a new physical block according to one embodiment of the present invention;

FIG. 7 is a conceptual block diagram showing a process of mapping a new physical block according to another embodiment of the present invention; and

FIGS. 8 to 10 are flowcharts shown for illustrating a method of controlling a solid state storage system according to the embodiments of the present invention.

### DETAILED DESCRIPTION

Hereinafter, a solid state storage system and a method of controlling the solid state storage system according to one embodiment of the present invention will be described with reference to the accompanying drawings.

Each block of the block diagrams can represent a module, segment, or portion of code, which includes one or more executable instructions for implementing the specified logical function(s). It should also be noted that in some alternative embodiments, the functions noted in the blocks can occur out of order. For example, two blocks shown in succession can in fact be substantially executed concurrently or the blocks can sometimes be executed in reverse order depending upon the functionality involved.

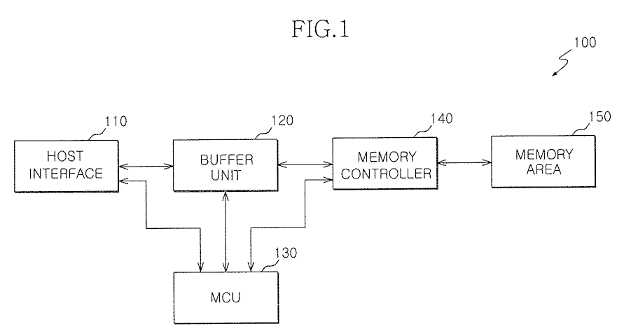

First, a solid state storage system according to one embodiment of the present invention will now be described with reference to FIGS. 1 to 3.

FIG. 1 is a block diagram showing an exemplary solid state storage system 100 according to one embodiment of the present invention. In this embodiment, the solid state storage system 100 is exemplified as a storage system using a NAND flash memory.

Referring to FIG. 1, the solid state storage system 100 includes a host interface 110, a buffer unit 120, a micro controller unit (MCU) 130, a memory controller 140, and a memory area 150.

First, the host interface 110 can be connected to the buffer unit 120. The host interface 110 can transmit and receive control commands, address signals, and data signals between an external host (not shown) and the buffer unit 120. An interface method between the host interface 110 and the external host (not shown) can, for example, be any one of a serial advanced technology attachment (SATA) method, a parallel advanced technology attachment (PATA) method, a SCSI method, a method using an express card, and a PCI-Express method.

The buffer unit 120 can buffer output signals from the host interface 110 or store mapping information between logical addresses and physical addresses. The buffer unit 120 can be embodied as a buffer using static random access memory (SRAM).

The MCU 130 can exchange control commands, address signals, and data signals with the host interface 110 or control the memory controller 140 using the above signals.

In particular, the MCU 130 according to one embodiment of the present invention can allocate continuous logical block addresses to different chips using a flash transfer layer (FTL) conversion. The MCU 130 can also perform a control operation such that a read/write operation is performed in a logical block address unit in response to a read/write command. As a result, the MCU 130 can uniformly distribute written data in a memory area. Further, the MCU 130 can perform additional lifespan management of a logical block corresponding to the logical block address. The MCU 130 performs a control operation such that mapping is made to physical blocks of chips other than the corresponding chip when a referred logical block has a high updating frequency.

The MCU 130 according to one embodiment of the present invention can prevent data storage areas from being concentrated in the same area and can implement global wear leveling (GWL) in which wear leveling of the data storage areas is not limited only to the corresponding chip. Further, both a multi-plane mode and an interleaving mode can be implemented according to an address allocation method.

The memory controller 140 can select a predetermined NAND flash memory element ND from a plurality of NAND flash memory elements of the memory area 150, and provide a write command, a delete command, or a read command to the selected NAND flash memory element. The memory controller 140 can be controlled by a mapping method of the MCU 130. The memory controller 140 can perform a control operation such that continuously received data can be distributed and processed in the plurality of chips in the memory area 150 according to an interleaving method or a multi-plane method. The detailed description thereof will be made below.

The memory area 150 can be controlled by the memory controller 140 and data write, delete, and read operations can be performed in the memory area 150. In particular, the memory area 150 can be controlled according to the logical block addresses that are distributed and mapped by the MCU 130. As a result, data can be uniformly distributed and stored in all of the planes.

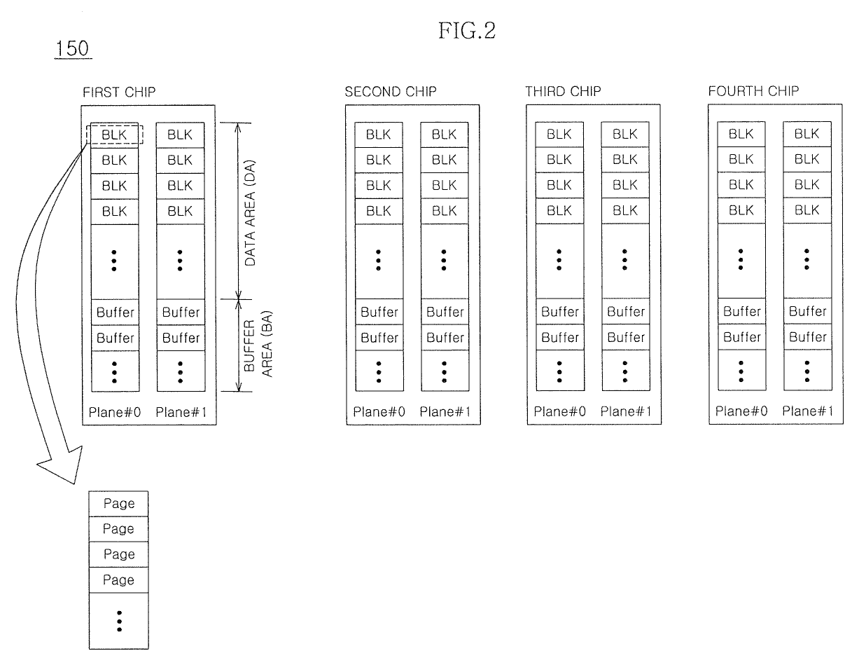

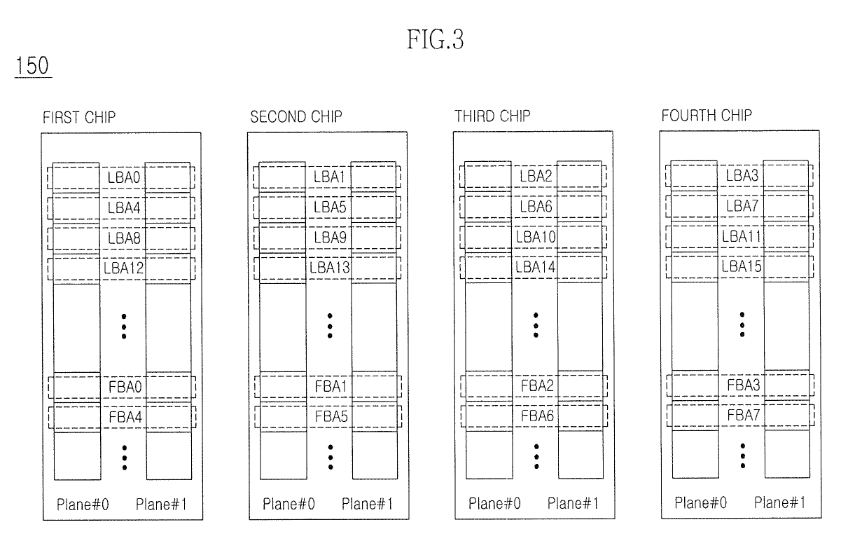

FIG. 2 is a block diagram showing a hierarchical structure of an exemplary memory area 150 that can be included with the system according to one embodiment of the present invention. FIG. 3 is a conceptual block diagram showing a logical block address mapping relationship according to one embodiment of the present invention.

Referring to FIGS. 2 and 3, the memory area 150 can be configured to include a plurality of chips, e.g., ‘a first chip, a second chip, . . . ’.

Each of the chips includes a plurality of planes, e.g., ‘plane#0 and plane#1’. Each of the planes ‘plane#0 and plane#1’ includes a plurality of memory blocks BLK. Each of the memory blocks BLK includes a plurality of pages that are grouped according to shared word lines. Each of the blocks ‘BLK0, BLK1, . . . ’ can have an arbitrarily set sector address (not shown).

Each of the planes ‘plane#0 and plane#1’ can be configured to include a main block, which is comprised of a predetermined area including available blocks BLK, and a spare block having an arbitrary storage block. Accordingly, the main block can be called a data block area (DB) and the spare block can be called a free block area (FB).

According to one embodiment of the present invention, the continuous sector addresses that designate different planes in the same chip are grouped together and logical block addresses ‘LBA0, LBA1, . . . ’ in a virtual page unit can be allocated to the groups of sector addresses. Further, buffers in the free block area (FB) of each of the chips that correspond to the logical block addresses ‘LBA0, LBA1, . . . ’ can be grouped together and buffer addresses ‘BBA0, BBA1, . . . ’ can be allocated to the buffers. Accordingly, the logical block addresses ‘LBA0, LBA1, . . . ’ can be allocated in the virtual page unit and a read/write operation is performed in the virtual page unit according to an external command.

Meanwhile, a file system method can be used as an operating system method for an external host (not shown) that controls the solid state storage system, such as the SSD. That is, a material structure method in which the external host (not shown) manages all raw data and management material related to the solid state storage system is generally called a file system. In such a file system, areas can be classified into a material area related to an operating system, an information area of the file system, an index management area for the material area and the information area, and a data storage area. At this time, the data storage area can be controlled in a cluster unit, e.g., a 16 Kbytes unit and a 32 Kbytes unit, which is a predetermined unit that can be managed by the external host (not shown). The cluster is different from a virtual block unit or a virtual page unit where the above-described memory area operates, and can be described in terms of the operating system that manages files. Here, for the convenience of explanation, the cluster unit suitable for the file system of the external host is described as a data handling unit of the file system and corresponding to a predetermined logical block address group. Accordingly, the logical block address group of the cluster unit can correspond to a group (not shown) of logical block addresses ‘LBA0, LBA1, LBA2, and LBA3’ of different individual chips to form one cluster. Further, the logical block address group can correspond to a group (not shown) of logical block addresses ‘LBA4, LBA5, LBA6, and LBA7’ to form one cluster.

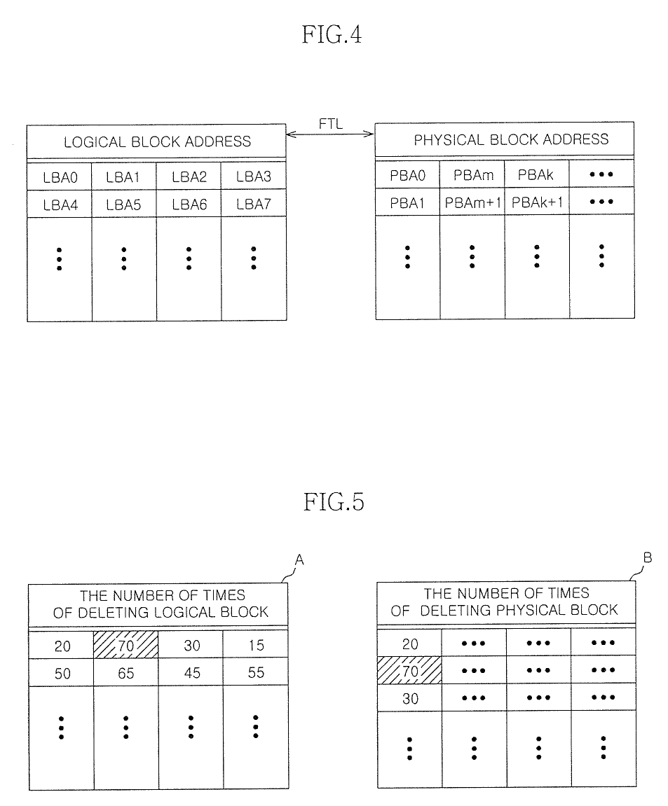

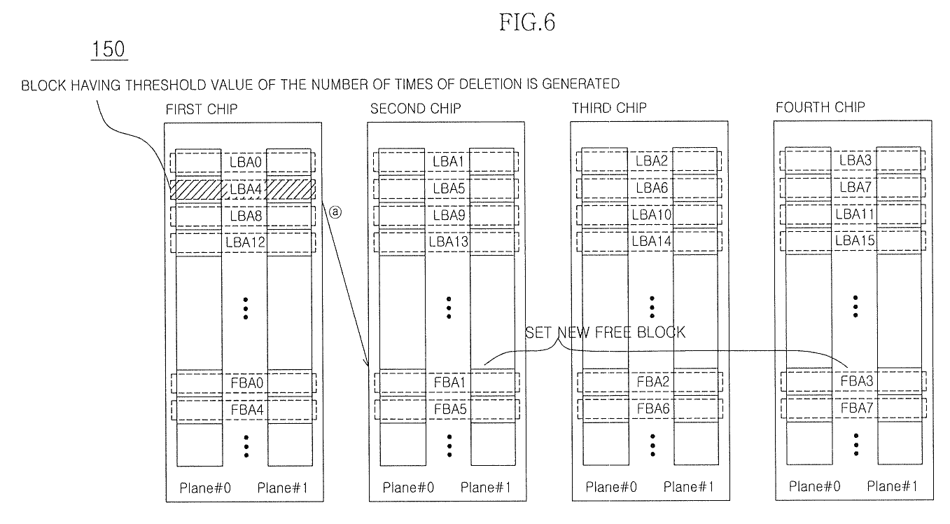

This will be described in further detail with reference to FIGS. 4 and 5.

FIG. 4 is a conceptual block diagram showing a mapping relationship between logical block addresses and physical block addresses according to one embodiment of the present invention. FIG. 5 is a block diagram showing a delete management table of logical blocks and a delete management table of physical blocks according to one embodiment of the present invention.

First, referring to FIG. 4, the logical block addresses ‘LBA0, . . . ’ can be distributed and mapped to the physical block addresses ‘PBA0, . . . ’ of all of the chips of the memory area (refer to reference numeral 150 of FIG. 3).

Specifically, the logical block address 0 ‘LBA0’ can map to the physical address block 0 ‘PBA0’, the logical block address 1 ‘LBA1’ can map to the physical block address m ‘PBAm’, and the logical block address 2 ‘LBA2’ can map to the physical block address k ‘PBAk’. It is understood that the continuous logical block addresses ‘LBA0, LBA1, . . . ’ are allocated to the physical blocks of the different chips, respectively.

Accordingly, the MCU 130 according to one embodiment of the present invention can generate the logical block addresses by grouping the sectors addresses in a predetermined unit and distributing and mapping the logical block addresses to the chips of the entire memory area. As a result, a control operation can be performed to sequentially map the continuous logical block addresses to the physical blocks of different chips.

Specifically, continuous large unit (bulk unit) data can be distributed and stored in substantially all the planes according to the logical block addresses that are distributed and mapped such that pages are designated in different planes. Thus, the generation of a specific plane having a low program frequency and having a concentration of large unit data can be prevented In this case, it is assumed that the large unit data exceeds a virtual page unit and the bulk unit data has a size of 2 Mbytes or more. Meanwhile, with respect to data of a small size, e.g., 512 Kbytes, the operation can be performed in a virtual page unit of a selected chip. As such, according to one embodiment of the present invention, address mapping can be performed using distribution mapping and a handling unit of a data area can be decreased. As a result, both a multi-plane method and an interleaving method can be used. That is, when the operation is performed on relatively small unit data, the operation can be performed according to the multi-plane method, and when the operation is performed on large unit data having a Mbyte size, the operation can be performed according to the interleaving method.

Meanwhile, according to one embodiment of the present invention, the number of times each logical block is deleted can be additionally managed, as shown in FIG. 5.

First, a delete management table A for the logical blocks and a delete management table B for the physical blocks are generated.

Whenever data updating is requested with respect to each of the logical blocks corresponding to the logical block addresses ‘LBA0, LBA1, . . . ’, the delete management table A for the logical blocks increases a number representing the number of times the corresponding logical block has been deleted and stores the number. Similarly, the delete management table B for the physical blocks increases a number representing the number of times the physical blocks have been deleted, which are mapped to the logical block addresses ‘LBA0, LBA1′, . . . ’ and in which data is actually processed, and stores the number. A block shown having oblique lines in each of the delete management table A for the logical blocks and the delete management table B for the physical blocks indicates a block where the threshold value for the number of deletions is generated. Accordingly, the number of deletions for the logical block designated by the logical block address can be therefore additionally managed and a new physical area can be mapped. Specifically, the physical areas that are mapped to the logical block addresses ‘LBA0, LBA1, . . . ’ can be remapped to correspond to the free blocks of different chips. When wear leveling is performed on a physical block for a logical block address that has a high frequency of being selected, the wear leveling is not limited to the corresponding chip only, but can be performed in a new chip.

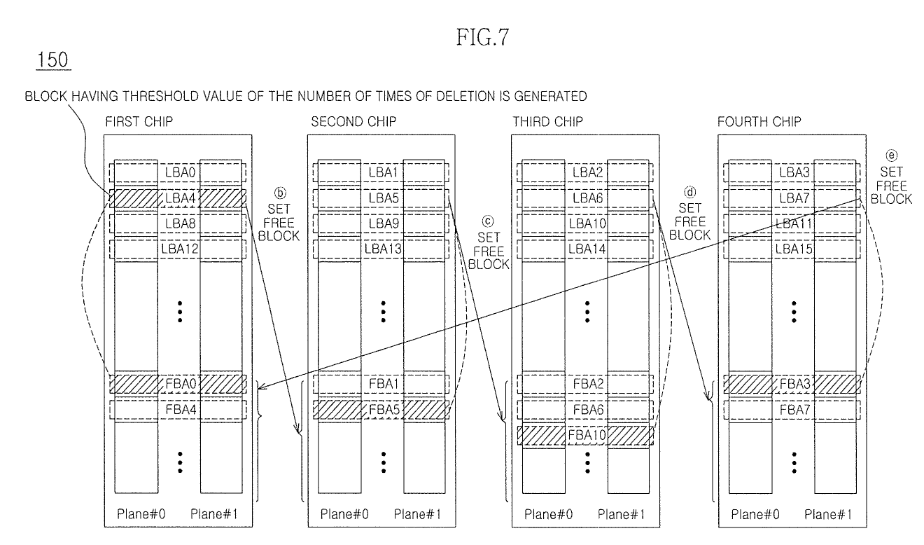

FIG. 6 is a conceptual block diagram showing a process of mapping a new physical block according to one embodiment of the present invention.

In FIG. 6, it is assumed that a block having met a threshold value for the number deletions is generated in the first chip.

According to one embodiment of the present invention, the MCU (refer to reference numeral 130 of FIG. 1), using the logical deletion management table (refer to table A of FIG. 5), knows when a logical block reaches a number of deletions corresponding to the threshold value The MCU can then remap the physical block corresponding to the logical block address ‘LBA4’, i.e., the logical block having reached the threshold value, such that the physical block corresponds to a free block of a new chip.

In performing the remapping, a free block having the least number deletions can be traced among the free blocks of the second to fourth chips with respect to the logical address group that forms the same cluster as the corresponding logical block address. The data of the free block corresponding to the logical block of the first chip and data of the newly traced free block can be switched.

For example, it is assumed that the free block corresponding to the logical block address ‘LBA4’ of the first chip is the free block having the free block address ‘FBA0’ of the first chip.

If the logical block address ‘LBA4’ of the first chip is frequently selected and the number of deletions for the corresponding logical block reaches the threshold value, a tracing operation (a) on the corresponding logical block starts.

That is, a free block having the smallest number of times of deletion is traced with respect to the logical address group that forms the same cluster as the corresponding logical block address across the second to fourth chips, not including the first chip. This is possible by performing a comparison operation of the number of deletions with respect to all of the free blocks in the second to fourth chips.

Data that is stored in the free block having the free block address ‘FBA0’ in the first chip and data of the newly traced free block having the least number of deletions among the free blocks allocated to the logical block addresses ‘LBA5, LBA6, and LBA7’ in the second to fourth chips are switched. That is, the data of the free block having the most deletions (reaching the threshold value) and the data of the free block having the least deletions are switched. Specifically, the free block that corresponds to the logical block address ‘LBA4’ of the first chip is switched to the free block of the new chip, and mapping is performed again. The number of deletions of the corresponding logical block is then reset.

In general, wear leveling is performed by managing the number of deletions for the physical blocks and determining the threshold value for the number of deletions. In the related art, when the wear leveling needs to be performed according to the threshold value for the number deletions, the wear leveling is individually and independently performed for each plane or for the same chip.

If a specific logical block address is continuously selected and the updating frequency of a specific cell area mapped to the specific logical block address increases, the lifespan of the corresponding chip is shortened despite wear leveling being performed. Accordingly, the overall performance of the solid state storage system is deteriorated even though cell use frequency in the same chip is equalized when a chip having a high updating frequency exists.

However, according to one embodiment of the present invention, if a specific logical block address is continuously selected, the specific logical block address is remapped to a cell area of a new chip. As a result, even though the specific logical block address is continuously selected, the presently mapped physical area can be mapped to a different chip according to the threshold value for the number of deletions, and thus the frequency of use for cells of each chip can be equalized. Accordingly, when wear leveling is performed with respect to a selected logical block address, the wear leveling is not limited to a single chip but can be performed on other chips. As a result, global wear leveling can be implemented.

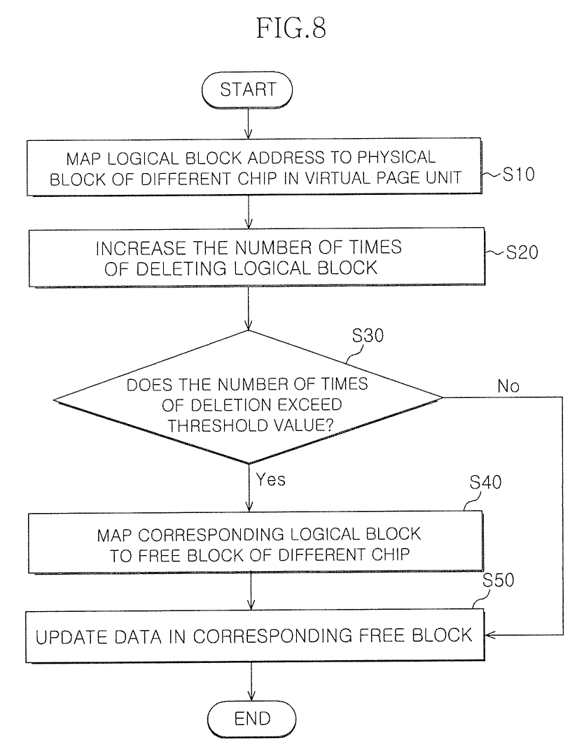

FIG. 7 is a conceptual block diagram showing a process of mapping a new physical block according to another embodiment of the present invention.

Referring to FIG. 7, descriptions of those features previously described with respect to FIG. 6 are omitted. Features of FIG. 7 distinguished from FIG. 6 are described below.

For the convenience of explanation, similarly to the case of FIG. 6, it is assumed that a block having met a threshold value for the number deletions is generated in the first chip.

According to another embodiment of the present invention, a round robin method is used where a free block for a logical address group forming the same cluster as a corresponding logical block address of the next chip is traced and newly mapped.

The round robin method can be described as a method where a newly mapped free block among the free block groups is traced using a circular path. For example, the free block of the first chip is traced in the second chip, the free block of the second chip is traced in the third chip, the free block of the third chip is traced in the fourth chip, and the free block of the fourth chip is traced in the first chip.

Specifically, the free block that corresponds to the logical block address ‘LBA4’ of the first chip traces a free block for a logical address group that forms a cluster including a corresponding logical block address of the chip 2, instead of a free block having the free block address ‘FBA0’ of the first chip. In this case, it is assumed that a traced free block having a logical block address ‘LBA5’ of the second chip is a free block having a free block address ‘FBA5’. Accordingly, the free block that corresponds to the logical block address ‘LBA4’ of the first chip is newly mapped to the free block having the free block address ‘FBA5’ of the second chip.

Meanwhile, a new free block for the logical block address ‘LBA5’ of the second chip is traced in the third chip according to the same method as mentioned above. In this case, it is assumed that a traced free block of the third chip is a free block having a free block address ‘FBA10’. Accordingly, the new free block for the logical block address ‘LBA5’ of the second chip is remapped to a free block having the free block address ‘FBA10’ of the third chip.

In the same manner, a free block for the logical block address ‘LBA6’ corresponding to the free block having the free block address ‘FBA10’ of the third chip is traced in the fourth chip. For example, when the traced free block of the fourth chip is the free block having the free block address ‘FBA3’, the logical block address ‘LBA6’ of the third chip is mapped to the free block having the free block address ‘FBA3’ of the fourth chip.

A logical block that has the logical block address ‘LBA7’ that corresponds to the free block having the free block address ‘FBA3’ of the fourth chip is mapped to the free block having the free block address ‘FBA0’ and the most number of deletions, among the free block group of the first chip.

That is, the block having met the threshold value for the number of deletions is generated in the first chip, but remapping is performed on all of the chips. As described above, after remapping is performed, the number of deletions for the corresponding logical block is reset such that repeating the remapping can be prevented at a subsequent data updating request.

As such, actual data storage areas are newly reconfigured using the number of deletions of the logical block address. Mapping is performed on all of the chips using a predetermined rule, i.e., a round robin method. As a result, the updating frequency of each cell can be uniformly controlled and an interleaving method can be maintained with respect to the continuous logical block addresses.

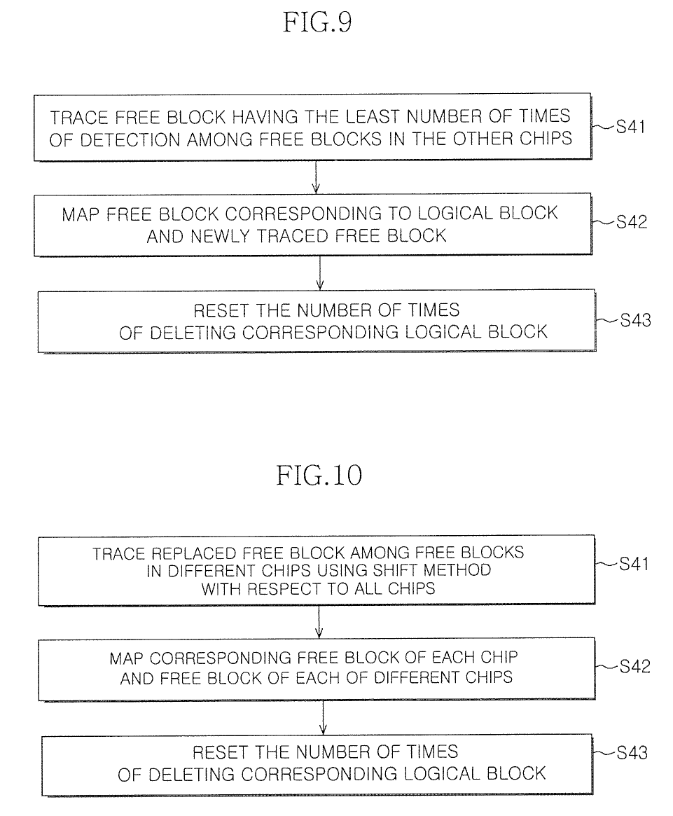

FIGS. 8 to 10 are flowcharts shown for illustrating a method of controlling a solid state storage system according to another embodiment of the present invention.

The method of controlling the solid state storage system according to an embodiment of the present invention will be described with reference to FIGS. 1 to 8.

First, the logical block addresses ‘LBA0, LBA1, . . . ’ in a virtual page unit are generated and mapped to the physical blocks of different chips (S10).

Sector addresses (not shown) are allocated to the individual blocks in the chips, such that continuous sector addresses (not shown) are allocated to different planes of the chips. At this time, the continuous sector addresses in the same chip are grouped, thereby generating the logical block addresses ‘LBA0, LBA1, . . . ’ corresponding to one virtual page unit. The continuous logical block addresses ‘LBA0, LBA1, . . . ’ are mapped to different chips. Uniform distribution mapping is performed with respect to all of the planes when the logical addresses and the physical addresses are mapped to each other such that data is distributed and arranged using the logical addresses.

The MCU 130 increases a count for the number of deletions of the logical block designated by the selected logical block address in response to a data updating request from the external host (S20).

That is, the MCU 130 increases a count for the number of deletions since previously written data needs to be deleted before new data may be written.

The MCU 130 determines whether the number of deletions of the corresponding logical block address exceeds the threshold value (S30).

If the number of deletions of the corresponding logical block address does not exceed the threshold value, data is updated in the corresponding free block to complete an updating command (S50).

If the number of deletions of the corresponding logical block address exceeds the threshold value, the corresponding logical block is mapped to a free block of a different chip (S40).

At this time, as shown in FIG. 9, the corresponding logical block is mapped to the free block of the different chip among the free blocks for the logical address groups of the chips that does not include the corresponding logical block, i.e., the second to fourth chips that form a cluster including the corresponding logical block address. A free block having the least number of deletions is then traced (S41). The free block corresponding to the logical block and the newly traced free block are then mapped (S42). After the free blocks are mapped, the number of deletions of the corresponding logical block is reset and deleted (S43).

According to another method, as shown in FIG. 10, the corresponding logical block is mapped to the free block of a different chip with respect to all of the chips that include the corresponding logical block and a free block that needs to be replaced is traced among the free blocks of the different chips according to a round robin method (S41). As described above, free blocks for logical addresses that are allocated to the different chips and that form a cluster including the corresponding logical block address are continuously traced with respect to a newly mapped free block of the corresponding logical block and the chips that are associated with the corresponding logical block. However, a chip is generated in which data is stored in the free block corresponding to the logical block since the free blocks are traced according to the round robin method to implement an inter-chip interleaving mode. Therefore, the corresponding free block of each chip and a free block of each of the different chips are mapped (S42). After the free blocks are mapped, the number of deletions of the corresponding logical block is reset and deleted (S43).

Then, according to the predetermined mapping rule, data is stored in the newly mapped free block to complete an updating command (S50).

As such, according to one embodiment of the present invention, logical block addresses can be allocated to different chips such that both an interleaving method and a multi-plane method corresponding to a data operation control method can be performed. Further, a read/write operation unit of data is controlled such that it becomes a virtual page unit having a small size. As a result, it is possible to efficiently manage the lifespan of cells.

When wear leveling is performed on the data storage areas, global wear leveling is performed on all the chips rather than only the corresponding chip in contrast to local wear leveling. Accordingly, the lifespan of the cells can be uniformly managed.

While certain embodiments have been described above, it will be understood that the embodiments described are by way of example only. Accordingly, the device and method described herein should not be limited based on the described embodiments. Rather, the devices and methods described herein should only be limited in light of the claims that follow when taken in conjunction with the above description and accompanying drawings.

What is claimed is:

1. A solid state storage system, comprising:
a memory area including a plurality of chips; and
a micro controller unit (MCU) using a number of times logical blocks that correspond to selected logical block addresses are deleted when wear leveling is performed on the memory area.

2. The solid state storage system of claim 11
wherein according to a write request, the MCU increases the number of times the logical block that corresponds to a selected logical block address is deleted, determines a threshold value for the number of deletions of the logical block, and remaps the logical block address.

3. The solid state storage system of claim 2,
wherein the MCU traces the logical block having a predetermined number of deletions and a newly mapped free block.

4. The solid state storage system of claim 3,
wherein the solid state storage system uses a file system method that manages data in a cluster unit, and
the MCU groups the logical block addresses by a predetermined number corresponding to the cluster unit.

5. The solid state storage system of claim 4,
wherein the MCU traces a free block having a least number of deletions among free blocks corresponding to the grouped logical block addresses that form the cluster unit including the selected logical block address in the chips that do not include the logical block.

6. The solid state storage system of claim 5,
wherein the traced free block having the least number of deletions and the logical block are mapped.

7. The solid state storage system of claim 4,
wherein the MCU traces free blocks corresponding to the logical block addresses that form the cluster unit including the selected logical block address with respect to a chip subsequent to the chip including the logical block.

8. The solid state storage system of claim 7,
wherein the subsequent chip is determined according to a round robin method.

9. The solid state storage system of claim 7,
wherein the MCU continuously traces free blocks newly mapped to all of the chips other than the logical block and performs new mapping on predetermined logical blocks of all of the chips.

10. A solid state storage system, comprising:
a memory area including a plurality of chips; and
a micro controller unit (MCU) allocating continuous logical block addresses to different chips of the plurality of chips, respectively, and performing wear leveling on the memory area,
wherein, when a logical block of a chip generates a threshold value or more for a number of deletions, the MCU allocates the logical block to physical blocks of the plurality of chips other than the chip including the logical block to support global wear leveling.

11. The solid state storage system of claim 10,
wherein according to a write request, the MCU increases a number of times a selected logical block address is deleted, determines the threshold value for the number of deletions of the logical block, and remaps the logical block.

12. The solid state storage system of claim 11,
wherein the MCU traces the logical block having a predetermined number of deletions and a newly mapped free block.

13. The solid state storage system of claim 12,
wherein the solid state storage system uses a file system method that manages data in a cluster unit, and
the MCU groups the logical block addresses by a predetermined number corresponding to the cluster unit.

14. The solid state storage system of claim 13,
wherein the MCU traces a free block having a least number of deletions among free blocks corresponding to the grouped logical block addresses that form the cluster unit including the selected logical block address in the chips that do not include the logical block.

15. The solid state storage system of claim 14,
wherein the traced free block having the least number of deletions and the logical block are mapped.

16. The solid state storage system of claim 13,
wherein the MCU traces free blocks corresponding to the logical block addresses that form the cluster unit including the selected logical block address with respect to a chip subsequent to the chip including the logical block.

17. The solid state storage system of claim 16,
wherein the subsequent chip is determined according to a round robin method.

18. The solid state storage system of claim 16,
wherein the MCU continuously traces free blocks newly mapped to all of the chips other than the logical block and performs new mapping on predetermined logical blocks of all of the chips.

19. The solid state storage system of claim 10,
wherein each of the plurality of chips includes a plurality of planes and each of the plurality of planes includes a plurality of blocks, and
the MCU groups the plurality of blocks included in different planes of the plurality of planes in the same chip and allocates the logical block addresses to the groups of blocks.

20. The solid state storage system of claim 19,
wherein the logical block addresses define a virtual page unit, and
a read/write operation is performed in the virtual page unit.

21. A method of controlling a solid state storage system using a file system method that manages data in a cluster unit, comprising:
increasing a number of times a logical block designated by a selected logical block address is deleted when data for the selected logical block address is updated in response to a command from an external host;
determining whether the number of times the logical block address is deleted exceeds a threshold value for a number of deletions; and
mapping the logical block to free blocks of different chips when the number of times the logical block address is deleted exceeds the threshold value.

22. The method of claim 21, wherein the mapping of the logical block to the free blocks of the different chips includes:
tracing a free block, in the different chips that do not include the logical block, having a least number of deletions among free blocks corresponding to logical block address groups that form a cluster that includes the logical block address;
mapping the free block corresponding to the logical block and the traced new free block; and
resetting the number of times the logical block is deleted after the free blocks are mapped.

23. The method of claim 21, wherein the mapping of the logical block to the free blocks of the different chips includes:
tracing a replaced free block of a subsequent chip determined by a round robin method with respect to all chips that include the logical block;
mapping a continuously selected logical block in each chip and the traced free block of the subsequent chip; and
resetting the number of times the logical block is deleted after the continuously selected logical blocks are remapped.

24. The method of claim 23, wherein the tracing of the replaced free block includes:
tracing a free block of a subsequent chip corresponding to the logical block address that forms the cluster unit including the selected logical block address and a free block of a subsequent chip mapped to the logical block corresponding to the traced free block.

25. The method of claim 21, further comprising:
when each of the different chips includes a plurality of planes and each of the plurality of planes includes a plurality of blocks,
before the increasing of the number of times the logical block is deleted,
generating logical block addresses in a virtual page unit by grouping the plurality of blocks included in different planes of the plurality of planes in the same chip and mapping the logical block addresses to physical blocks of the different chips.
